(19) United States
(12) Patent Application Publication
(10) Pub. No.: US 2008/0190985 A1
(43) Pub. Date: Aug. 14, 2008

(54) Housing for an Energy Source in a Hand-Operated Device Having a Mechanism for Ejecting the Source

(76) Inventor: Ronald Almeras, Tournon (FR)

Correspondence Address: LOWE, HAUPTMAN, GILMAN & BERNER, LLP (ITW), 1700 DIAGONAL ROAD, SUITE 300, ALEXANDRIA, VA, 22314, US

(21) Appl. No.: 11/910,024

(22) PCT Filed: Apr. 25, 2006
(86) PCT No.: PCT/IB2006/001015

§ 371 Date: Sep. 28, 2007

(30) Foreign Application Priority Data
Apr. 26, 2005 (FR) 05 04155

(51) Int. Cl. B25C 1/08

(52) U.S. Cl. 227/10

(57) ABSTRACT

The housing is intended to receive a source introduced by means of its head and pushed into a position ensuring good transmission of energy. The housing includes a mechanism for converting a transverse movement towards the interior of the housing imparted by a pusher element of the mechanism accessible from the exterior of the housing into an orthogonal movement for ejection of the source.

### RELATED APPLICATIONS

The present application is based on International Application No. PCT/IB2006/001015 filed Apr. 25, 2006, and claims priority from French Application Number 0504155 filed Apr. 26, 2005, the disclosure of which is hereby incorporated by reference herein in its entirety.

### FIELD OF THE INVENTION

The invention relates to gas fastening devices drawing their combustion and drive energy for a piston for driving a fastening element from a gas cartridge connected to a transmission element for filling the combustion chambers of these devices, this element generally being formed by a solenoid valve.

### BACKGROUND OF THE INVENTION

Possible gas fastening devices are, e.g. nail drivers, hammers and other staplers.

These devices include a housing for receiving a cartridge held in this housing by means integral with the devices, such as, e.g. a flap, a cap or a fork slid into a channel in the outlet fitting of the cartridge.

During operation, the cartridge and the solenoid valve are connected together in a sealed manner by means of a connecting adapter integral with the cartridge and hooked on to an intermediate inlet fitting integral with the solenoid valve.

### SUMMARY OF THE INVENTION

The invention relates firstly to a housing for a gas cartridge in a gas fastening device, the housing being intended to receive a cartridge introduced by means of its head and pushed into a position in which the head of the cartridge is hooked on to a gas transmission element of the fastening device, the housing being characterised in that it includes a mechanism for converting a transverse movement towards the interior of the housing imparted by a pusher element of the mechanism accessible from the exterior of the housing into an orthogonal movement for ejection of the cartridge.

The ejection mechanism preferably includes a collar designed to be driven in the direction of ejection by the pusher of the transmission element and unhook the head of the cartridge.

The pusher and the ejection collar are also preferably designed to cooperate by a wedge effect.

In the preferred embodiment of the invention, the pusher includes a ring intended to be passed around the cartridge and the ejection collar, also intended to be passed around the cartridge, includes an internal annular rim for driving the cartridge.

It has already been stated hereinabove that the invention arose from a problem encountered with gas fastening devices. However, the Applicant does not intend to limit the scope of his application solely to the use of gas cartridges in fastening devices.

A gas cartridge is an energy source for a gas combustion device in which sealing must be ensured between the cartridge and the gas transmission element. The invention of this application in fact applies equally to any other energy source for a hand-operated device, such as electric fastening devices operating with the aid of a battery which must also be removable from its housing without too much difficulty.

The invention therefore relates more generally to a housing for an energy source in a hand-operated ice, the housing being intended to receive a source introduced by means of its head and pushed into a position ensuring good transmission of energy, the housing being characterised in that it includes a mechanism for converting a transverse movement towards the interior of the housing imparted by a pusher element of the mechanism accessible from the exterior of the housing into an orthogonal movement for ejection of the source.

### BRIEF DESCRIPTION OF THE DRAWING

The invention will be more readily understood with the aid of the following description of the preferred embodiment of the housing for a cartridge of the invention, with reference to the accompanying drawings, in which:

FIG. 1 is a cut-away perspective view of a cartridge with its adapter and the ejection mechanism for the cartridge, prior to ejection;

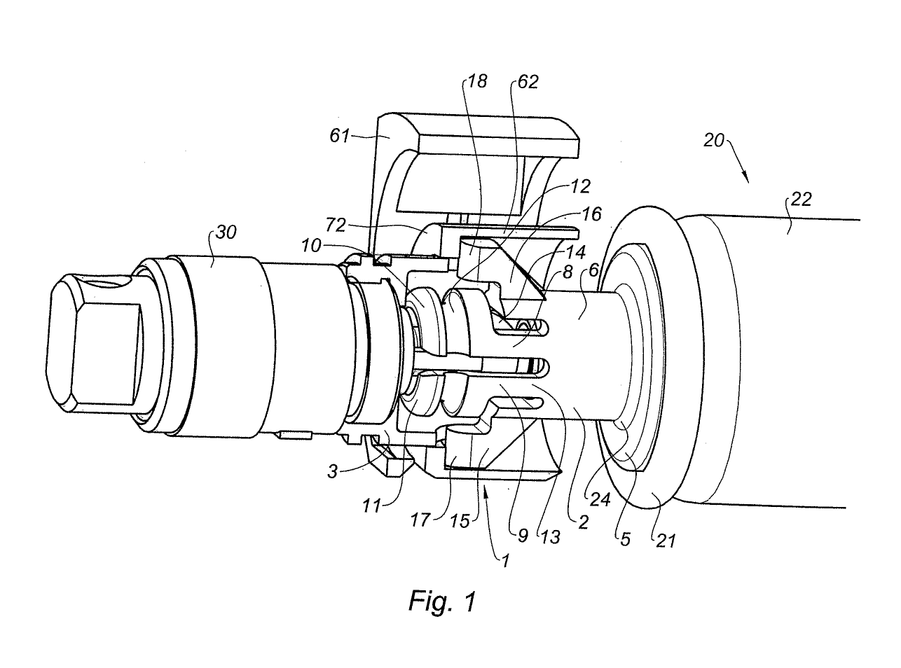

FIG. 2 is an analogous view to that of FIG. 1, but after the operation of the ejection mechanism:

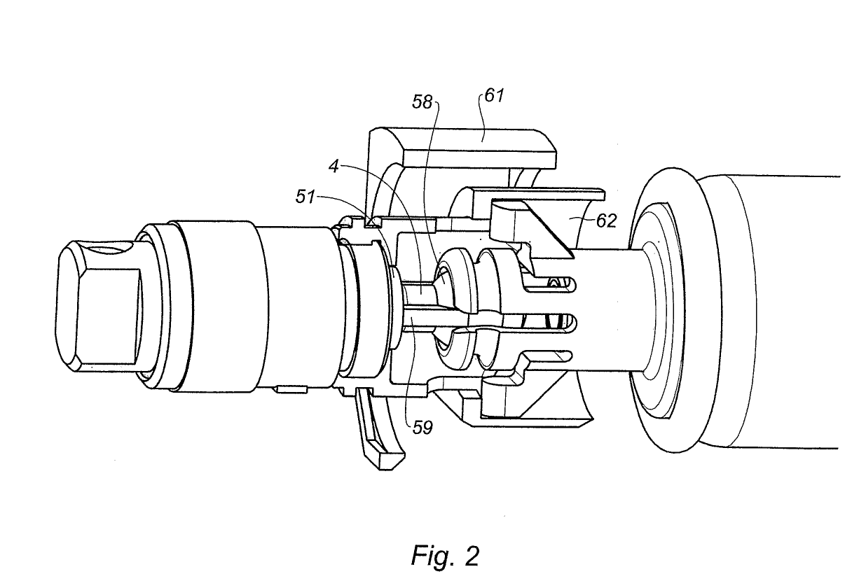

FIG. 3 is a lateral view of the cartridge and its adapter and of the ejection mechanism:

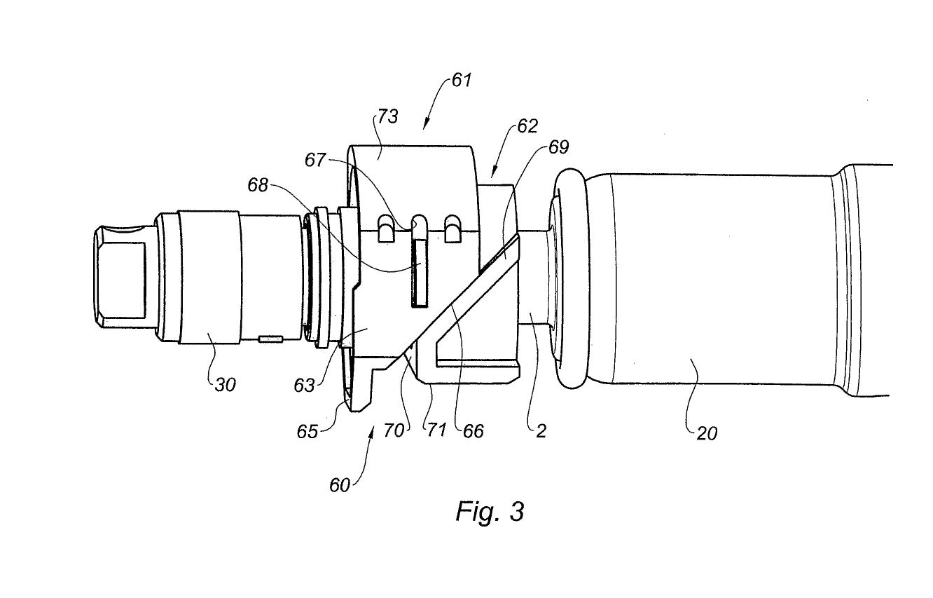

FIG. 4 is an exploded view of the ejection mechanism as the solenoid valve is being mounted in the housing, and

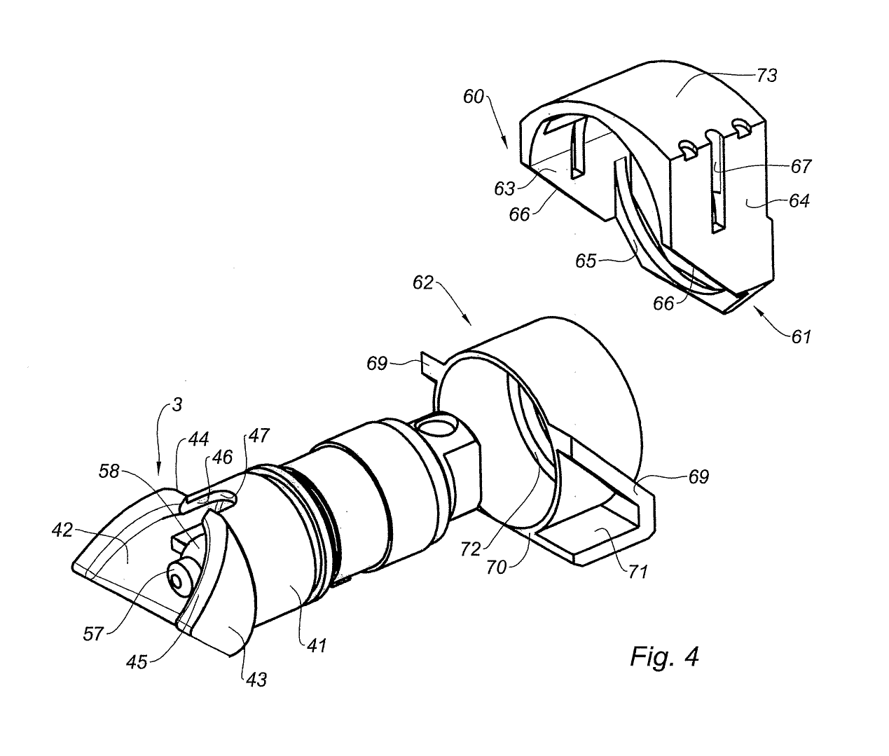

FIG. 5 is a perspective view of the housing with the cartridge and the solenoid valve.

The elements which will now be described are intended to

i) connect a propellant cartridge 20 and a solenoid valve 30 for filling the combustion chamber of a hand-operated gas device, in this case a fastening device, by mutual hooking and locking in rotation and

ii) unhook the cartridge from the solenoid valve in order to eject it from its housing.

### DETAILED DESCRIPTION OF THE DRAWING

A fastening device for fastening fastening elements by means of a piston driven by compressed gas comprises an internal combustion engine comprising a combustion chamber intended to be supplied with compressed gas from a gas cartridge 20 in order to drive the piston itself intended to drive the fastening elements.

In this particular example, connecting members 1 intended to connect the solenoid valve 30 and the compressed gas cartridge 20 are provided.

The cartridge 20 of generally cylindrical shape is provided in an internal casing with the compressed gas in the liquid state and between the internal casing and an external casing 22 with a propellant. A circular edge 21 forms a continuation of the external cylindrical wall of the cartridge 20, at one of the ends of the latter. A male outlet fitting connected to the internal casing projects from the cartridge by means of a base 24 situated in the centre of the dish formed in the interior of the edge 21.

The solenoid valve 30 of generally cylindrical shape is provided at one of its ends with an inlet fitting connected in the interior of the solenoid valve to an outlet fitting (not shown). The inlet fitting is in this case a male fitting.

The connecting members 1 comprise
an adapter 2, in this case mounted on the cartridge 20, for hooking, angular indexing and locking in rotation;
a skin 3, in this case mounted on the solenoid valve 30, for angular indexing and locking in rotation:
an intermediate fitting 4 mounted on the solenoid valve 30, and
a sealing connector mounted in the adapter 2.

Adapter

The adapter 2 serves as a support for the sealing connector, serves for the mutual hooking of the cartridge 20 and the solenoid valve 30 and serves for the angular indexing and locking in rotation of the cartridge and the solenoid valve in cooperation with the skirt 3 of the solenoid valve 30.

The adapter 2 includes a flat, in this case, circular supporting base 5 to which fastening legs extending into the internal dish of the edge perpendicularly to the base and spread apart in order to engage with the internal wall of the edge 21 are connected.

On the other side of the fastening legs, the supporting base 5 is extended by a tubular chamber 6 having a considerably smaller section than the base 5. This chamber is slotted in an axial plane in order to give two slightly hinged hooking legs 8, 9 substantially halfway along the chamber. The free ends 10, 11 of the hooking legs are designed as semi-circular beads each forming an internal circular hooking shoulder for a spherical element of the intermediate fitting of the solenoid valve. A peripheral groove 12 for receiving a torus (not shown) for pressing the legs together is formed on the exterior of the free ends 10, 11 of the hooking legs 8, 9. So that they can be hinged, the hooking legs are partially hollowed out so that they are generally in the form of an inverted U hinged about the ends 13 of the two parallel legs of the U.

Ribs or fins 15, 16 project radially towards the exterior in the same axial plane from the internal portions of the hollowed-out windows 14 in the two hooking legs 8, 9 in order to provide transverse end bosses 17, 18 projecting slightly from the chamber 6, extending substantially in the transverse plane of the groove 12 and intended to be received in the bottoms of lateral channels in the indexing and locking skirt 3. These end bosses, as described in more detail hereinafter, will play a role in the ejection of the cartridge from its housing.

Indexing and Locking Skirt

This is a generally tubular element provided on one side with an end 41 for fastening to the solenoid valve and on the other side with indexing flanges 42, 43″ formed in a tubular portion which is thicker than the fastening portion, has the same internal wall and therefore forms an annular external shoulder 44. In general, these indexing flanges 42, 43 have been obtained by the intersection of the said thick tubular portion by a tubular element having an axis orthogonal to the axis of the skirt, giving edges 45 acting as angular indexing ramps. Each indexing flange has two ramp portions 45 inclined in opposite directions with top rounding between them and extending substantially over 180°. Two lateral anti-rotation channels 46 each extending in the same axial plane to a bottom 47 in the thin tubular fastening portion 41 have been cut out in the axial plane separating the two flanges 42, 43.

Intermediate Fitting

This is a tubular spacer 4 provided at one end with a sleeve portion 51 for covering the fitting of the solenoid valve. The intermediate spacer 4 is provided at the other end with a small tubular end portion 57 intended to be introduced into the sealing connector. A spherical hooking portion 58 connected to the sleeve portion 51 by the spacer 4 and two positioning ribs 59 is situated adjacent to the end portion 57.

The spacer 4 is traversed from one end to the other by a duct for the passage of gas.

Sealing Connector

This is a seal having a generally tubular shape.

The unhooking and ejection mechanism 60 is mounted on the housing 80 for the cartridge 20 and the solenoid valve 30. It is an elongated housing having a length substantially equal to the sum of the lengths of the cartridge 20, its adapter 2 and the solenoid valve 30. The housing 80 having a generally parallelepipedal shape includes a cradle-shaped bottom 81 for receiving the cartridge, the bottom being provided with an opening 82 for the passage of a pusher 61 intended to unhook the adapter 2 of the cartridge from the intermediate fitting 4 of the solenoid valve by means of an ejection collar 62.

The pusher 61 includes a cylindrical skirt portion 73 extended by two flat lateral blank portions 63, 64 joined together by a ring portion 65. The pusher extends axially over a small length from the plane of the ring 65. The cylindrical skirt portion 73 is designed to plug the opening 82 provided in the bottom 81 of the housing.

The plane of the ring portion 65 completes the cylinder of the skirt portion 73 in order to receive the adapter 2 of the cartridge 20.

The lateral blanks 63, 64 have a generally trapezoidal shape, each having a ridge 66 inclined towards the rear and towards the exterior and serving as a ramp element for the wedge effect with the ejection collar. A groove 67 is formed in each of the blanks in order to receive a corresponding rib 68 projecting from the internal wall of the cradle-of the housing and to thereby guide the sliding of the pusher 61 when it is operated.

The ejection collar 62 is a tubular element to which two ribs 69 inclined towards the rear and towards the exterior and intended to cooperate with the ridges 66 of the pusher 61 in order to cause a wedge effect are added laterally and on the exterior, but in this case in an integrally moulded manner. The ribs 69 are joined together by a transverse flat portion 70 and a plate 71 substantially tangential to the tubular portion of the collar. The flat connecting portion 70 is extended in its plane by an internal annular rim 72 for pushing and driving the cartridge.

The pusher 61 and the collar 62 form a mechanism for converting a transverse movement towards the interior of the bottom of the housing (when the pusher 61 is pushed so that it is displaced transversely to the axis) into an orthogonal ejection movement, in this case in a direction parallel to the axis by virtue of the wedge effect exerted by the ramps 66 of the pusher 61 and the ribs 69 of the collar 62.

The pusher 61 and the collar 62 are free in their housing in the transverse direction. Irrespective of the position of this assembly, the introduction of the cartridge acts by means of the bosses 17, 18 on the rim 72 of the collar 62, which drives the pusher 61 by the wedge effect and repositions the assembly 61, 62.

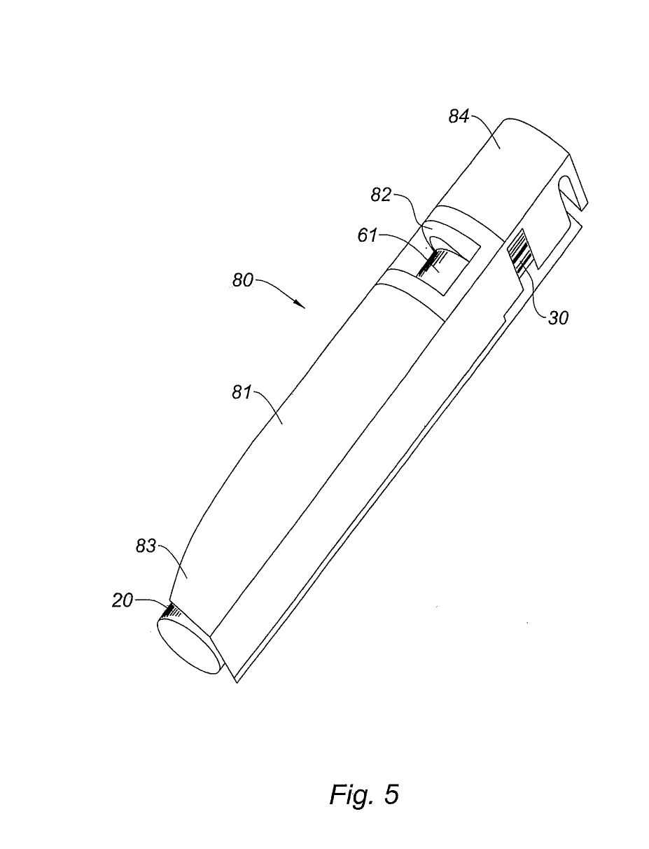

In FIG. 5, the pusher 61 is in the retracted position, the cartridge 20 not yet itself being in the connecting position.

The connection of the solenoid valve 30 and the cartridge 20 will now be described. Once the intermediate fitting 4 has been introduced by means of its sleeve 51 into the solenoid valve 30, it is covered by the skirt 3 by fastening the skirt 3 to the solenoid valve by means of the end 41, in this case by screwing the, in this case, tapped end 41 of the skirt 3 on to the threaded edge of the solenoid valve.

The solenoid valve 30 is then placed in the housing 80 together with its indexing and locking skirt 3 by introducing them from the rear 83 towards the front 84 through the ejection collar 62 and the ejection pusher 61, the solenoid valve then resting on circular transverse supporting ribs.

Once the adapter 2 has been generally mounted on the cartridge 20 after the cartridge has been introduced into its housing in the device, it is pushed towards the solenoid valve. If the angular position of the cartridge is not correct, the fins 15, 16 of the adapter 2 come to a stop against the edges 45 of the skirt by means of their end bosses 17, 18.

By virtue of their inclination, as they continue to push the cartridge towards the solenoid valve, the fins 15. 16 will slide on to the edges 45, thereby rotating the cartridge as a result of the ramp effect, i.e. until these fins engage in the lateral channels 46 in the skirt 3. As soon as the fins 15, 16 begin to engage in the channels 46 in the skirt 3, with the cartridge then being locked in rotation, the hooking legs 8, 9 of the adapter 2 come into contact with the spherical portion 58 of the intermediate fitting 4, which spreads them apart until, as a result of the action of the return torus (not shown), when the spherical portion is situated at the hollowed-out windows 14 the}′ are pressed together again over this spherical portion in order to ensure that the adapter of the cartridge is hooked on to the intermediate fitting of the solenoid valve. i.e. the cartridge 20 and the solenoid valve 30 are connected together. The fins 15, 16 then bear b> means of their end bosses 17, 18 against the annular rim 72 of the ejection collar 62, itself bearing against the ring 65 of the pusher 61.

The unhooking of the cartridge 20 from the solenoid valve 30 will now be described. When the operator presses on the pusher 61, he drives it in transverse displacement which, by virtue of its ramps 66 and the ribs 69 of the collar 62 and therefore by a wedge effect, is converted into axial displacement which drives the ejection collar 62 towards the exterior.

By means of its annular rim 72, the collar 62 drives the fins 15, 16 of the adapter 2 by means of their bosses 17, 18, and therefore drives the cartridge 20 towards the exterior in order to eject it from its housing.

1. Housing for an energy source in a hand-operated device, the housing being intended to receive a source introduced by means of its head and pushed into a position ensuring good transmission of energy, the housing being characterized in that it includes a mechanism for converting a transverse movement towards the interior of the housing imparted by a pusher element of the mechanism accessible from the exterior of the housing into an orthogonal movement for ejection of the source.

2. Housing according to claim 1, in which the energy source is a gas cartridge for a gas fastening device, the housing being intended to receive the cartridge introduced by means of its head and pushed into a position in which the head of the cartridge is hooked on to a gas transmission element of the fastening device.

3. Housing according to claim 1, in which the ejection mechanism includes a collar designed to be driven in the direction of ejection by the pusher and unhook the energy source.

4. Housing according to claim 3, in which the pusher and the ejection collar are designed to cooperate by a wedge effect.

5. Housing according to claim 1, in which the pusher includes a ring intended to be passed around the energy source and the ejection collar, also intended to be passed around the energy source, includes an internal annular rim for driving the energy source.
